(19) United States
(12) Patent Application Publication
(10) Pub. No.: US 2004/0063801 A1
(43) Pub. Date: Apr. 1, 2004

(54) Absorbent material and method for the production of the same

(76) Inventor: Klaus Roehm, Walddorfhaeslach (DE)

Correspondence Address: VENABLE, BAETJER, HOWARD AND CIVILETTI, LLP, P.O. BOX 34385, WASHINGTON, DC, 20043-9998, US

(21) Appl. No.: 10/415,992

(22) PCT Filed: Nov. 6, 2001
(86) PCT No.: PCT/EP01/12840

(30) Foreign Application Priority Data
Nov. 6, 2000 (DE) 100 54 734.6

(51) Int. Cl. C08J 9/00

(52) U.S. Cl. 521/82

(57) ABSTRACT

The invention relates to a method for producing an absorbent material for water, aqueous solution and bodily fluid. The absorbent material consists of at least two components Q and B, namely of component Q containing 100 parts by weight of particles and of component B containing between 2 and 250 parts by weight of water. A homogeneous blending of the components produces an absorbent material in flake form, which forms cavities as a result of the mutual adhesion of the particles and/or covalent and/or ionic bonding. Directly after blending, the bulk and/or cavity volume has increased by at least 1% by volume in relation to the sum of the individual volumes of the components used, which correspond to 100% by volume.

The present invention relates to a method for producing microporous and macroporous absorbent materials for water and aqueous solutions and body fluids, consisting of at least two components Q and B. The invention furthermore relates to the absorbent materials, layers and molded parts produced with this method, as well as their uses and in particular their technical uses.

Materials for absorbing aqueous liquids, in particular polymers, so-called super absorbers, are known from numerous publications, wherein modified natural polymers and partially or completely synthetic polymers are used. The synthetic super-absorbers are frequently polymers on a (meth-) acrylic acid base, which are present in a partially neutralized form as alkali salt and are no longer water-soluble, but only capable of swelling in water. The super-absorbent polymers, henceforth only called “SAP,” are generally mechanically communited, dried and ground up following the polymerization. These polymers can be produced with standard production method, for example as described by A. Echte in, “HANDBUCH DER TECHNISCHEN POLYMERCHEMIE” [Manual for Technical Polymer Chemistry]; VCH-Verlagsgesellschaft mbH [publishing house], Weinheim, 1993, or in “Modern Superabsorbent Polymer Technology,” by F. L. Buchholz, A. T. Graham, Wiley-VCH Publishing House, 1998. Examples of substances that can in principle be produced according to these methods are listed in material list A1 (non-biodegradable polymers). In addition, commercially available super-absorbers can also be used, such as the ones described in “Modern Superabsorbent Polymer Technology” by F. L. Buchholz, A. T. Graham, Wiley-VCH Publishing House, 1998, page 19.

These products are typically used for sanitary items such baby diapers and incontinence articles, soil improvement agents and nutrient, as water reservoirs for plants, as sealing material in the cable-producing industry, in underground engineering and as bonding material for pollutants leaking to the environment, as well as for non-aqueous lipophilic substances.

One area of use for the SAP is to protect in particular high-quality cable products by sealing them in against penetrating water. This sealing effect is also known under the term “gel-blocking,” where only the surfaces of the absorbent particles will swell, thus preventing the liquid from reaching the internal areas. Thus, the swollen absorbent particles that stick together form a blocking layer against any incoming liquid. The effect desired in this area of application is primarily achieved with extremely fine powders having a grain size <300 μm, typically <100 μm, so as to achieve the highest possible sealing effect and quantitative efficiency for sealing relatively small volumes. In part, the SAP particles are deposited to form layer-type sealing elements on and/or between textile or cellulose support layers, so as to permit an efficient and dust-free operation during the cable production, e.g. as described in reference DE 19801680. For the above-stated reasons, SAP systems consisting of textile structures are also used. In this area of application, biodegradable SAP base materials such as guar gum are also used, which are adapted as to their characteristics to the particular use in additional treatment steps, e.g. the surface cross-linkage, treatment with biocides and corrosion-inhibitors and hydrophobing and which for the most part prevent the biodegradability. On the whole, these products have a high life span of >10 years.

Another area of application where the gel-blocking effect is also purposely used is for the permanent sealing of through openings in underground engineering, e.g. for pipeline openings and similar openings through brickwork. The production of sealing materials and elastic sealing elements of this type, for example, is described in the WO 00/60017, which is herewith introduced as reference and considered part of the disclosure. These materials are preferably produced on a polymer base, capable of swelling, with filler materials and grain sizes ranging essentially from 5 μm to 800 μm.

Large amounts of all different types of variations of the SAP are used in hygienic and incontinence products. In particular powdered products having a broad grain spectrum of ranging from 10 μm to 1000 μm, typically a grain spectrum ranging from 150 μm to 850 μm, are used for practical purposes in this area of application. Micro-particles of <150 μm are not desirable because of the dust behavior and the toxic characteristics if inhaled. Following absorption of the liquid, the contact between the swollen particles is increased due to the increased SAP content, thus resulting in the gel-blocking effect that is not desirable for this use.

The gel-blocking effect of the polymers can be suppressed with surface-cross-linking methods. All different types of surface cross-linking agents and methods are used for this. The methods known from prior art for the surface cross-linking are described, for example, in reference DE 10016041, which is herewith introduced as reference and is considered part of the disclosure. In particular, this reference discloses a method for the after-treatment of the above-mentioned polymers and the use of a solution consisting of at least a three-valent cation for restoring the gel-permeability and reducing the dust wear by friction. This leads to improved caking behavior and gel-blocking behavior during the final use, e.g. for producing hygienic articles.

The agglomeration of absorbent particles, also referred to as caking behavior, is based on the adhesion effect among the absorbent particles, which was detected early on. It was discovered that this occurs especially in humid environmental conditions, such as with increased humidity in the air, and particularly often if finer particles are used. Since the SAP used for hygienic applications consist of mixtures of particles with different grain sizes, the fine particles that are also generated during the production and/or further processing stage in particular represent a problem.

Reference DE 69323297, which is herewith introduced as reference and is thus considered part of the disclosure, discloses a method for producing an absorbent material in the form of a foil from absorbent resin particles, formed through the mutual adhesion of the resin particles and used, in particular, for hygienic articles. The final absorbent elements are formed with additional additives and cross-linking agents. The examples provided in reference DE69323297 show that a temporary agglomeration occurs following the contact between the resin particles and the specified amount of water of 15% to 150%, which is not considered advantageous.

Reference EP 0309187, herewith introduced as reference and considered part of the disclosure, discloses a SAP with improved handling, resulting from the immobilization of the powdered SAP when water or salt solutions are added in amounts of 20 to 80% by weight of the resulting hydrate (100% by weight). The hydrate can be introduced into the hygienic articles through extrusion, sprinkling or spraying, wherein the maximum liquid absorption capacity of the SAP is influenced only insignificantly. Additional substances used for the treatment of hygienic articles are herewith listed as well, e.g. ethylene glycol and glycerin. The agglomerate resulting when SAP and water are mixed is sticky. A flake-type micro structure or macro structure with cavity formation of the aforementioned agglomerates is not described in this reference.

U.S. Pat. No. Reference 5,002,986 discloses an absorbent material produced with a high-speed mixing unit, which forms agglomerates consisting of fine individual particles of a surface cross-linking means and an aqueous solution, wherein this reference is hereby entered as reference and considered part of the disclosure. The absorbent material has an absorption time of 20 seconds or less and a free absorption capacity of >30 ml/cm³. The absorbent material is surface cross-linked and agglomerates to form larger particles under the effect of a high-speed mixer. The polymer particle base for achieving the free absorption capacity of >30 ml/cm³ should have a particle distribution of 100% <300 μm and no more than 40%<=150 μm. During the high-speed mixing operation, the polymer base particles additionally come in contact with an aqueous solution of an ionic surface cross-linking agent, which is present in amounts of 1-20% by weight and a concentration for the surface cross-linking agent of 0.05 to 10% by weight. Water-soluble organic or inorganic mixtures can be used in this case as surface cross-linking agent. It is advantageous if aqueous solutions of ionic metal cations, an amino or imino cation having a valence of two are used. The absorbent material produced with the aforementioned method is used in particular for hygienic products. Comparisons show that the finer the polymer particles, the better the absorption time of the particles cross-linked on the surface according to this method. Thus, it follows that the moistened particles have a better absorption time owing to their greater surface area.

A porous absorbent material having a macro structure and cross-linking among the particles and a cavity volume of more than 10 cm³ in the dry state is described in reference EP0595803, herewith introduced as reference and considered part of the disclosure. The cross-linking aggregate consists of several precursor particles (precursors) of a water-absorbent, hydrogel-forming polymer and a cross-linking agent in amounts of 0.01 to 30 parts by weight for 100 parts by weight of the precursor particles, which causes a cross-linking with covalent bonding between the precursor particles. As a result of the natural particle structure of the precursor particles, macro-structured cavities form between the precursor particles. These pores have interconnected cavities, thus making the macro-structure permeable to liquid. The precursor particles have a particle size of <600 μm and primarily a particle size of <300 μm. The individual precursor particles can furthermore contain fibers and all the precursor particles can be cross-linked on the surface. The precursor particles can also contain pores with interconnected cavities as a result of physical association (adhesion).

The cross-linking agent primarily consists of the substance group ethylene glycol, glycerol, trimethylol propane, 1,2-propanediol, or 1,3-propanediol.

It is the object of the invention to produce absorbent materials, in particular for technical areas of applications, such as for the flood protection and retaining of water used for extinguishing fires or similar uses, requiring on the one hand a higher swelling agent volume for absorbing water or aqueous liquids and, at the same time, at least an almost complete filling of the cavities. A high effective absorption rate is also required because of the costs relative to the amounts used.

For an effective use of higher amounts of swelling materials, it is also necessary to avoid the gel-blocking effect, so as to achieve in the final analysis a cost-effective solution. For this, in particular macro-structured absorbent materials can be used, particularly on a SAP base, as previously disclosed in references U.S. Pat. No. 5,002,986 and EP0595803. An increased sealing effect against water may also be required, which is effective immediately and/or becomes effective to a significant degree after a few seconds and/or minutes and reaches a 100% sealing effect later on, e.g. after several minutes. The gel-blocking effect is again required for this. As a rule, it also results in an increase in the gel rigidity. A purposely intended, time-displaced filling of the cavity and sealing of two spaces is important in this case.

The biodegradability of the swelling agents used normally conflicts directly with the durability of this same swelling agent, even if subjected to normal environmental influences.

It is the object of the invention to provide an absorbent material, which does not have the above-mentioned disadvantages.

This object is solved with the features in claims 1 and 24. Advantageous embodiments, useful modifications as well as the use according to the invention are formulated in the independent use claims.

The invention provides a production method, which makes it possible to use standard absorbent materials as cost-effective base products that are processed further to form macro-structured final products in a three-dimensional form, used in particular for technical applications.

The use of standard swelling agents, which have the lowest possible potential for pollution and/or present the least amount of danger to the environment, e.g. are in the lowest water endangerment category, is intended to have only an insignificantly affect on the environment when used during flooding. Absorbent materials used as water or nutritional reservoirs for plants are preferred for this, e.g. those produced for some time by the company Stockhausen and marketed under the trade name “Stockosorb.” The material is a potassium cross-linked acrylamide/acrylic acid copolymer. Extensive studies on the use with plants are available for this. These absorbent materials, however, exhibit a relatively slow liquid absorption/swelling behavior and present a danger to water in the water quality category (WGK) 1. There are three categories for the grain-size distribution, ranging from <0.2 mm to >3 mm.

Especially preferred is also the use of cost-effective standard absorbent materials with rapid liquid absorption, such as the product Favor Pac 210, produced by the company Stockhausen, which is a cross-linked sodium polyacrylate. These absorbent materials exhibit a rapid liquid absorption/swelling behavior and are in the water endangerment category WGK 1. They are used in particular for absorbing liquid from packaging materials and also when in contact with food items, such as during transport of frozen fish. This product has grain sizes ranging from 100 μm to 800 μm and a water retention, meaning water absorption, of 80 g/ml SAP under pressure (80 g/cm²).

Owing to the fact that for specific technical uses, e.g. for sealing in cables, non-biodegradable super absorbers as well as biodegradable guar gum are used, it is obvious that the technology for further processing of a mostly non-biodegradable guar gum is also available for extreme environmental conditions and is used on a regular basis. It is in this field, in particular, that experience stretching back several years, in part even decades, is available. A guar gum product with the name Fakopol 100 by the CHT Company, was used for this, if applicable in the form of a surface cross-linked product with hydrophobic characteristics, which has poor biodegradability and a small grain size of <50 μm.

Cellulose-based absorbent materials such as methyl cellulose, if necessary in combination with synthetic resins, cellulose ether, if necessary in combination with polyvinyl acetate, carboxyl methyl cellulose, if necessary with hydrophobic characteristics are also suitable for the purpose of sealing and/or a delayed sealing effect.

The following shows a method for producing an absorbent material for water, aqueous solutions and body fluids, which method is characterized in that the absorbent material consists of at least two components Q and B, namely a swelling agent (the component Q) with 100 parts by weight of particles and the component B of water with 2 to 250 parts by weight, relative to the 100 parts by weight of the component Q.

These two components are homogenized inside a mixer for a predetermined mixing period until a cavity-forming flake develops based on the mutual adhesion of the particles to each other and/or due to covalent and/or ionic bonding.

Immediately after the mixing process, the bulk and/or cavity volume increases by at least 1 volume % relative to the sum of the individual volumes of the components used, corresponding to 100 volume %.

As a rule, an increase in the bulk and/or cavity volume immediately after the mixing operation by at least 1 to 1000 volume %, preferably 5 to 500 volume %, and especially preferred 50 to 300 volume %, can generally be detected relative to the sum of individual volumes of the components used, which represent 100 volume %. The volume increase generally remains approximately constant, even after 24 hours, regardless of the point in time at which it is detected. In individual cases, the bulk volume can also increase or decrease noticeably during this 24-hour period.

As shown in reference EP0595803, interconnected cavities are created as a result of the cavity structure, so that the macro structure is liquid-permeable, meaning liquid can pass through. This is also important for many technical uses.

To be sure, the reference U.S. Pat. No. 5,002,986 acknowledges in particular the importance of the large particle surface that increases with the particle size. However, it does not provide concrete information on the density, the bulk volume and/or the cavity volume of the porous absorbent material that forms agglomerates.

Reference EP0595803 does not provide qualitative information on the pore increase and/or the cavity structure, relative to the condition of the particle-shaped absorbent materials and/or as compared to different swelling agents. The minimum volume of the macro structure described in the non-swollen (circumscribed dry volume) condition, in particular used as a layer, is at least 10 mm³ and typically 500 mm³.

However, since the bulk volume behaves at least proportional to the existing cavity volume, the capillary effect is higher as well and the gel-blocking effect is therefore lower and/or less likely, particularly during pressure loads that more or less reduce the cavity structure of a macro structure.

Particularly for technical applications, considerably higher amounts of SAP are used for one application, representing a volume multiple (>5 to 2000 times) of the amount of approximately 25 g SAP per product used in baby diapers, generally used without fluff as distributing layer and/or mixing component. Individual incontinence articles for grownups can easily contain approximately 100 g SAP per product.

The German patent based on EP0595803, with a cationic amino epichlorohydrin aduct as surface cross-linking agent discloses a preferred macro structure density of 0.7 to 1.3 g/cm³ and an even more preferred a macro structure of 0.9 to 1.0 g/cm³. A significant cavity formation in the macro structure, as defined according to our invention, does not follow from this, which is also shown in the respective photographic illustrations for this publication.

A layer-type absorbent material with 15 to 150 parts per weight of water, formed through adhesion of the individual particles among each other, is described in reference DE6932397, which corresponds to EP0624618B1 and is hereby introduced as reference and considered part of the disclosure. This reference also shows a far-reaching surface cross-linking. Information on the layer density is provided only all-inclusive with respect to the layer dimensions of 0.3 to 5 mm and the unit area weight 0 f 100 to 300 g/m².

Until now, separate water-conducting structures have been used, e.g. textiles in the layer or tube form, mostly in the form of a covering or mixed-in capillary materials for technical applications using larger amounts of absorbent materials for primarily aqueous liquids. Macro structures with webs for producing a capillary effect have become known (DE69408275T2) in the area of binding agents, in particular for non-aqueous liquids.

The absorbent material described in the WO 00/60017 and used for sealing purposes in underground construction, particularly for pipeline through openings, which has a grain distribution of essentially <100 μm and a high share of filler materials has a high tendency toward caking and thus is mostly unusable for the intended application. The product therefore must be protected prior to use against normal environmental humidity by tightly enclosing it in a plastic sleeve and must be categorized highly sensitive to moisture. The water transport is via the textile hose and/or in particular via the capillary effect of the filler materials. No specific cavity structure exists.

The method according to the invention for producing cavity-forming and flake-type micro structures and macro structures can be used in particular for the particles described in the WO 00/60017, which are shown in the powdered form and are considered part of the disclosure.

As a result of using highly developed and high-capacity polymers of this type, which are commercially available, the component Q has already been subjected to a surface treatment. As described in reference DE10016041, for example, this component preferably was subjected to an after-treatment for restoring the gel-permeability following mechanical damage, in particular using a solution of at least one salt of a cation having a valence of at least three. Primarily metal salts, e.g. aluminum sulfate, are used for this. As shown in this reference, the agglomerates generated during this after-treatment are broken down and/or their formation is avoided as a result of using specific processing conditions, such as the mixing time length, wherein a dependence exists for the water supply via the salt solution. A targeted agglomerate formation in conjunction with a cavity structure is not described herein.

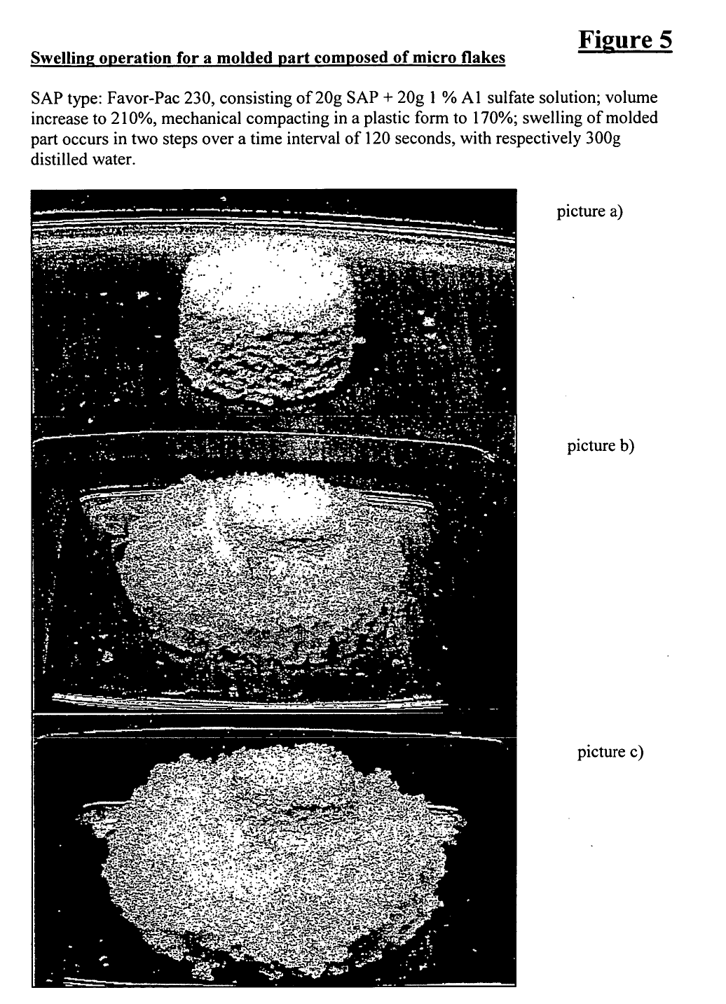

The properties of metal salts as surface cross-linking agents for particles were discovered early on and were used later on in different variations, e.g. in the previously mentioned U.S. Pat. No. 5,002,986. The advantages to be mentioned for such a macro structure are good properties for the gel stiffness, particularly following the swelling operation with a water absorption of >25 times and/or 50 times. The highly absorbent material also retains a stable form, as is shown in FIG. 5 and described in example 3. It means that the individual bonds (physical association=adhesive, covalent and ionic) between the particles and/or the micro-flake are stronger than the swelling pressure of the individual particle and/or the micro-flake, thus ensuring the cohesion of the total micro-flake bond. As a result of the gel-type structures, the micro-flakes can also deform sufficiently, so as to ensure on the whole a stable micro-structure form.

It has furthermore turned out that the micro-flakes have a strong elastic reaction, starting with a specific amount of water or aqueous liquid that is absorbed, e.g. >50 weight % of water, which can be reconstructed under the microscope. That is to say, they resume their original shape once the pressure load is removed, e.g. via a cover glass, and thus represent the elastic gel condition.

This elastic behavior can also be detected clearly in a similar form for the macro structure. Proof of this elasticity can be provided immediately after the component mixing and/or up to 24 hours later with the aid of the elastic behavior under a load (EVL=elastic deformation under load value) of at least 5N/dm², preferably >20N/dm², especially preferred >30N/dm², relative to the comparable value without load and a 95% spring-back to the original state.

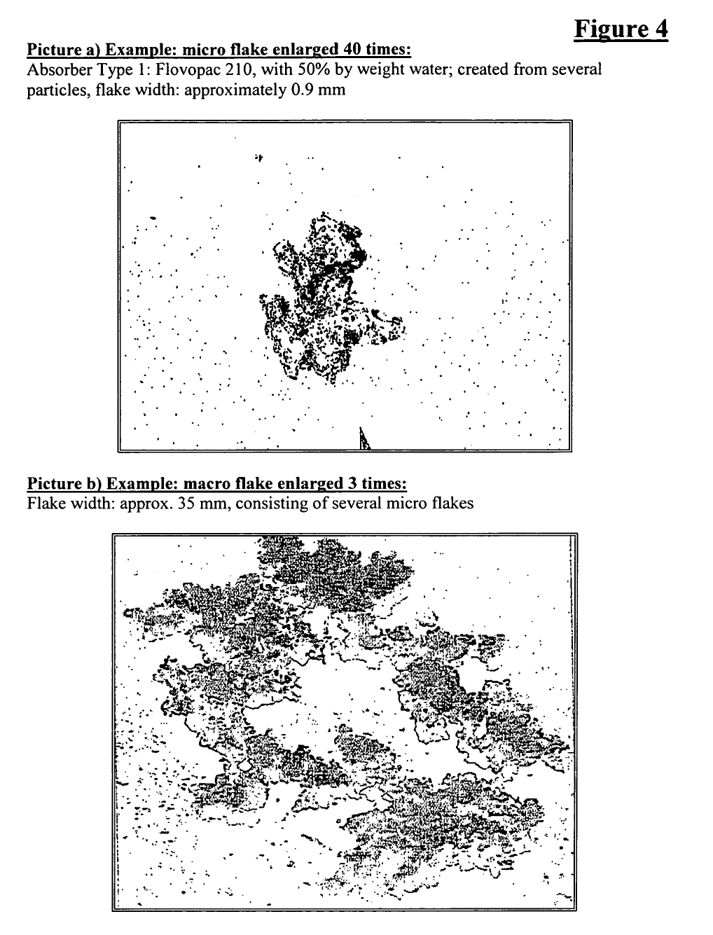

The component Q can furthermore consist of a combination of different swelling agents and a mixture of one or more of the different swelling agents listed in the Material Lists A1 and A2 within a single flake forming a micro-flake structure and/or in a mixture and/or compound of several individual flakes that form a macro-flake structure. A micro-flake structure (a) and a macro-flake structure (b) are shown as examples with the illustrations in FIG. 4.

Several micro-flake structures as a rule form the macro-flake structure as a result of mutual adhesion of the particles and/or covalent and/or ionic bonding, which can represent a separate and, if necessary, considerable share in forming the cavity volume among the micro flakes. If necessary, this can be achieved through the admixture of in particular the bonding agents, adhesive agents and surface cross-linking agents as well as filler materials such as fibers and aggregation inhibitors.

The combination of different swelling agents, as well as the grain size distributions, in particular can also be aimed at making use of the different specific properties of the swelling agents and/or the grain-size distributions as well as the particle shapes/contours for creating reservoirs and distribution areas within an optional macro structure. This can also be used to influence the chronological course of a swelling action with respect to achieving the highest possible liquid absorption and sealing effect and, in particular, the intended combination of the two.

Additional physical effects and chemical reactions can also occur or be triggered, e.g. the release of gases or odors, discoloration and increase in the bonding forces, particularly the adhesion to the surfaces of optional bodies, such as during the protection against floodwaters. Cellulose-based absorbent materials/aggregation inhibiting materials/bonding agents such as methyl cellulose, if necessary in combination with synthetic resins, cellulose ether, if necessary in combination with polyvinyl acetate, carboxyl methyl cellulose, if necessary with hydrophobic properties are used for sealing purposes and/or to obtain a delayed sealing effect.

The method according to the invention is also characterized by a macro-flake structure with an optional three-dimensional form or layering and/or contour and/or distribution intensity of the micro-flake structure and, in particular, is aimed at creating reservoir areas and distribution areas within an optional macro-flake structure. These can be produced in particular with the methods listed in the reference documents, for example through pouring, spraying on, extruding, flocculating, rolling out. In order to mix the components for the absorbent material, standard mixing apparatuses can be used and in particular a very simple mixing unit or stirring apparatus, preferably a horizontal mixer or a mortar mixer. The selected mixing tools for the mixer are adapted to the respective individual case and preferably operate in the range of 200 to 1000 rotations/minute (rpm). For component shares higher than 10%, particularly of the component Q, which have grain sizes smaller than 100 μm and especially smaller than 50 μm, it is preferably if gravity mixers or fluid-bed mixers are used.

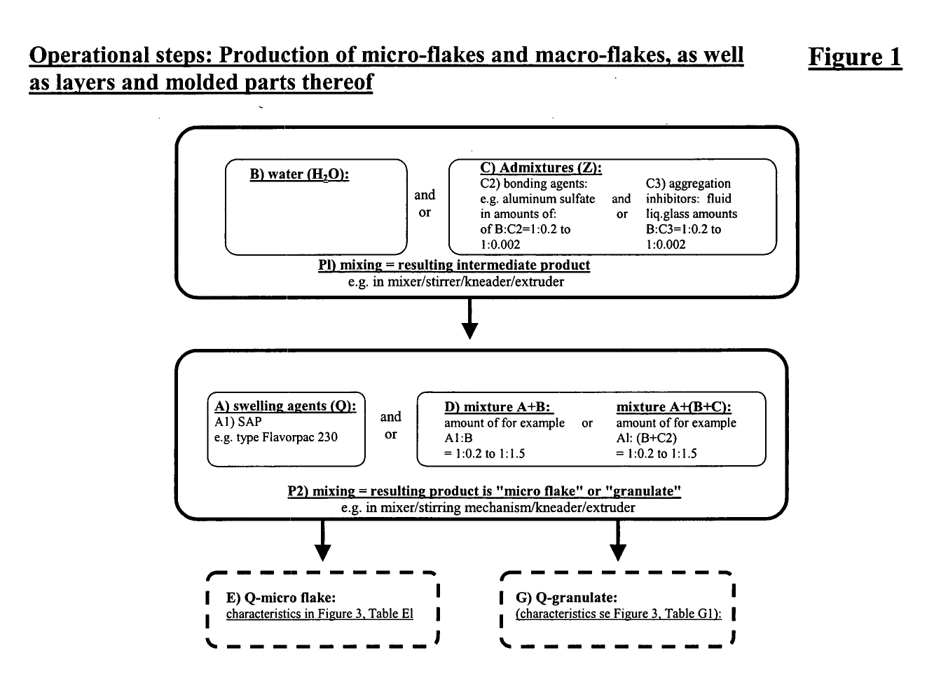

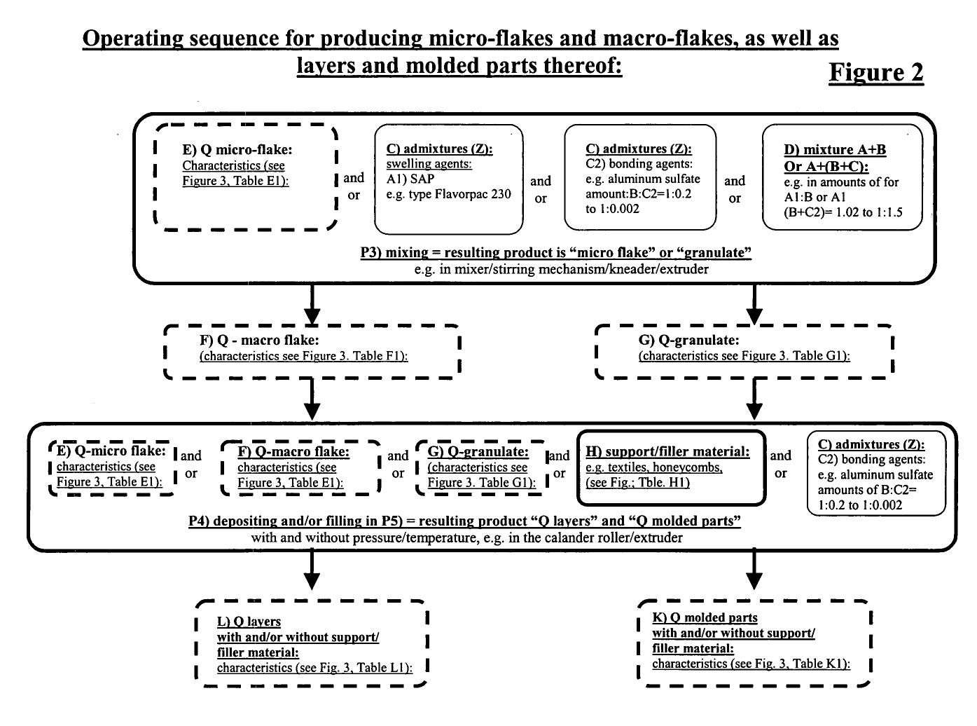

FIGS. 1 and 2 show the basic sequence of operations for producing micro and macro flakes as well as layers and molded parts from these.

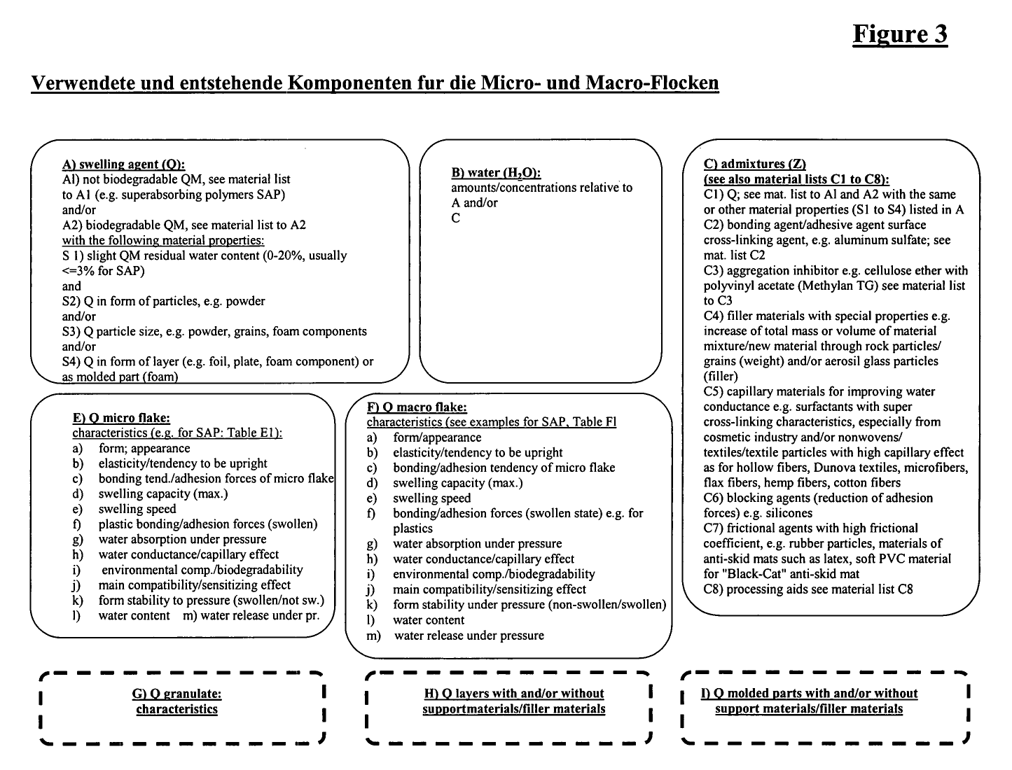

FIG. 3 provides an overview of components used and created for producing the micro and macro flakes.

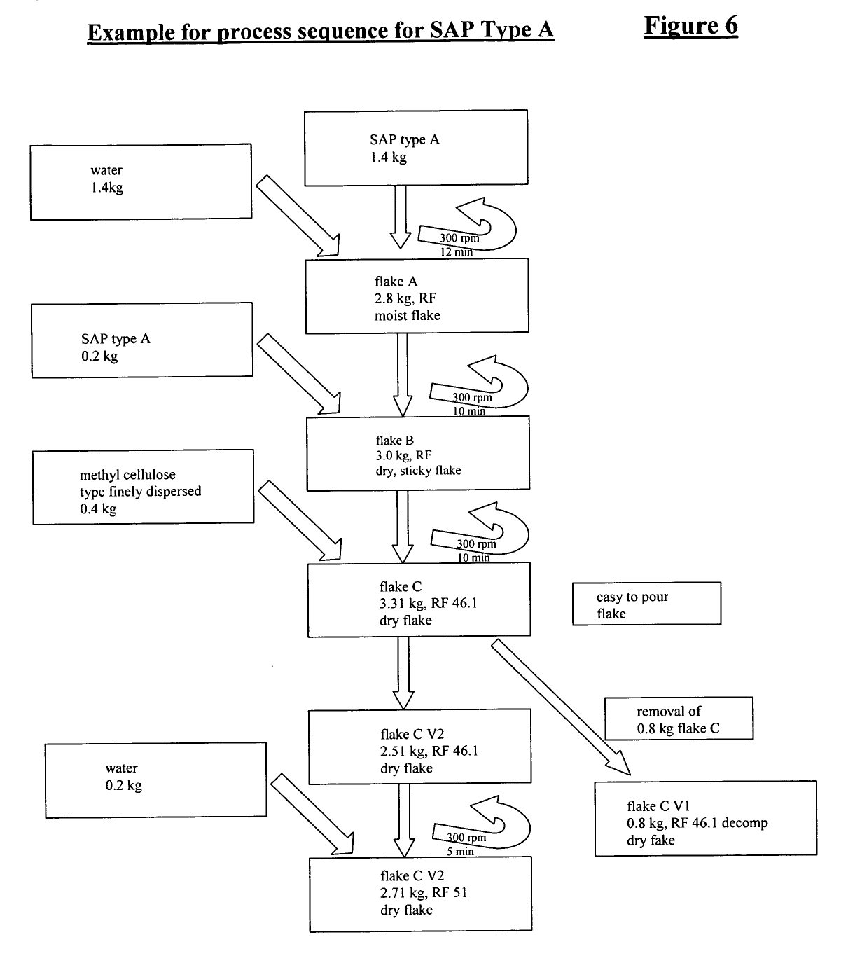

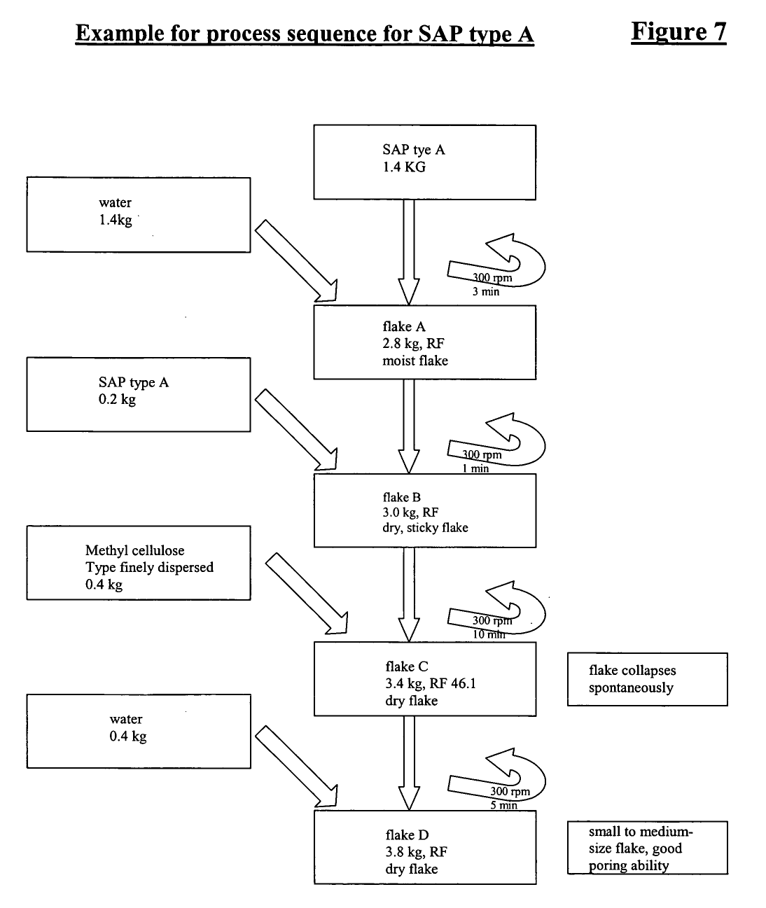

The operational steps described in FIGS. 6 and 7 for producing the micro and macro flakes are realized with a “Technikums”¹ horizontal mixer/reactor having a maximum 15 l reactor volume. The SAP of the type A, used in this case, corresponds to the product Favor-Pac 230 by the company Stockhausen. The materials used were added at the appropriate times in accordance with the course diagram. Thus, easily pourable flakes can be produced from slightly sticky flakes when adding finely dispersed methyl cellulose in the form of the product Methylan TG. The relative moisture listed for the flakes in this case is in the range of approximately 46%. By adding the methyl cellulose, the time-delayed gel-blocking effect that is superimposed for sealing purposes is achieved during the swelling operation. ¹Note: Term refers to a technical college; “Technikum”=engineering school

### Testing Methods

### Test Method 1

The bulk volume for the starting conditions of the SAP powder was determined in a 50 ml measuring cylinder.

Following production of the micro flakes, the bulk volume of the produced flakes was determined with the aid of a 250 ml measuring cylinder of a wide design by determining the increase in volume as compared to the starting volume for all components used=100 % volume.

The bulk volume 24 hours after the production was determined with the constraint that no additional air exchange or humidity exchange occurs within this time interval. This was achieved by closing and sealing off the beakers with household aluminum foil.

### Test Method 2

The relative humidity was determined with the aid of a sample, by drying, weighing and determining the residual water content in the substrate with the aid of a drying scale by the company Sartorius, type MA 30.

### EXAMPLE 1

Swelling agent flakes of the type Favor-Pac 230 were produced and the volume increase determined through mixing SAP powder with equal parts of different aqueous swelling agent solutions. The bulk volume was determined before and after the flake production with the testing method 1.

The flakes were produced as follows:

The starting amount of 25 g of SAP powder, type Favor-Pac 230, was placed into a 500 ml beaker and the total amount of 25 g water and/or the corresponding amount of aqueous swelling solution was added. The mixture was then mixed for 15 seconds with a manual mixer, manufactured by the company Krups, at a maximum mixing speed of 300 rpm. Immediately thereafter, the bulk volume was determined. Following this, the measuring cylinder was sealed with household foil to prevent air from entering and the bulk volume was determined once more after 24 hours.

Respectively 25 g of each of the following swelling agents were used:

distilled water

1% aluminum sulfate solution (Al₂(SO₄)₃.18 H₂O)

reactant resin solution: 5% solution of dimethyl-dihydroxy-methylene urea

| | SAP | | SAP flakes with | SAP flakes with |
|---|---|---|---|---|
| | powder | SAP flakes | (Al₂(SO₄)₃ | reactant resin |
| | dry | with water | solution 1% | solution; 5% |
| Volume | 44 + 25 | 142 | 160/144 | 136/124 |
| in ml | (h2O) | | | |
| Increase in | 0 | 206 | 220 | 188 |
| volume % | | | | |

### EXAMPLE 2

Swelling agent flakes of the type Favor-Pac 230 are produced and the increase in volume is determined by mixing SAP powder with different parts by weight of distilled water. The bulk volume before and after the production of the flakes was determined with the testing method 1.

The flakes were produces as follows:

The starting amount of 25 g of SAP powder, type Favor-Pac 230, was placed into a 500 ml beaker and the total amount of 25 g of water added. The mixture was then mixed for 15 seconds at the maximum speed of 300 rpm with a manual mixer, manufactured by the company Krups. Immediately thereafter, the measuring cylinder was sealed with household foil to prevent air from entering and the bulk volume was determined once more after a 24-hour period.

TABLE 2
increase in volume following flake production and after 24 hours:

| | Determining the increase | |
|---|---|---|
| | in volume % | Determining the increase |
| | Point in time: | in volume % |
| % share | immediately after the | Point in time: |
| of water | water is mixed in | after a 24-hour period |
| 20 | 271 | 134 |
| 35 | 152 | 87 |
| 50 | 131 | 225 |
| 75 | 122 | 170 |
| 100 | 88 | 87 |
| 150 | 65 | 71 |

Advantageous uses of the absorbent material according to the invention are described in the following.

The material is above all used to secure the position of containers, for example tanks.

The absorbent materials according to the invention are used as buoyancy protection for above-ground and underground containers, wherein the installation of the absorbent material on the inside and on the outside of the tank in particular achieves the sealing, keeping in place or weighing down of heating-oil tanks, gas tanks, chemical storage containers.

A different option for use is the preservation of buoyancy in boats, for example to prevent the sinking of a boat. For this application as well, the walls of the boat are simultaneously sealed by means of the absorbent materials.

Yet another use is for stabilizing the position and the positioning of ships and boats.

For this, the absorbent materials are used as weighing down and/or buoyancy element, for example, either on the outside or inside of the ship or boat. The goal is to maintain or change or return to the center of gravity for the boat. As example, the return to the normal position following the capsizing of a boat must be mentioned.

Furthermore, one or several floating or diving elements in the form of one or several extensions, possibly as for a trimaran on a boat, can lead to a position stabilization and/or position calming (smaller undulations) during heavy seas.

A different use is for the controlled lifting of boats in dry docks, wherein the position stabilizing and/or sealing of the outside walls of the boat can occur simultaneously.

The complete sealing and/or partial sealing of two rooms and/or room sections represents yet another type of use for the absorbent materials.

The absorbent materials can generally be used as sealing means. For example, they can be fitted in the non-swollen state as molded parts against the body to be sealed or against the cavity walls enclosed by a body. The molded parts can thus be form-fittingly connected to the respective body. Alternatively, it is also possible to form a sealing layer only after the swelling operation, following a time interval for the swelling operation.

The absorbent materials in particular can be used for sealing cables, wherein these enclose the cables to be sealed in the swollen and/or non-swollen condition. The absorbent materials in particular can be in the form of inherently stable foils and/or can be formed onto the carrier material.

These materials can also be used as sealing materials for storage sites. The absorbent material according to the invention and, if necessary, additional coverings or support materials can furthermore be used to form sealing elements. The sealing elements can be used to close off and seal sewer systems, pipeline openings and the like. Sealing with the absorbent materials in particular makes use of the fact that strong frictional forces or even an adhesive effect is achieved as a result of the viscous structure in the boundary areas between the bodies and the absorbent materials. As a result, the sealing effect is increased in the boundary area. The sealing elements can consist completely of homogeneously or heterogeneously structured absorbent materials.

Sealing elements can be designed in particular using the layering technique. The use of hydrophobic materials as carrier materials, e.g. in the form of non-woven gardening mats, is particularly advantageous. The absorbent materials as well as possibly added additives are fixated with bonding agents and/or adhesive agents to the carrier material. The bonding agents and/or adhesive agents are neutral or hydrophobic and can be aqueous or solvent-containing adhesive agents, hot glues, foam-type adhesives, methyl cellulose or the like.

The sealing elements produced with the layering technique can be used unchanged or in a further modified form for sealing windows, doors or the like. In the process, the supporting material can assume different geometric shapes or can be rolled up. It can also be used to produce pillow-type sealing elements.

In the same way, the absorbent materials can form a component for devices used to seal a pipe. For example, the pipe can be a discharge pipe that empties into the floor of a basement area in a building. In case of a flood, the water can be pushed from the sewage system via the pipe into the basement area. To avoid this, a support that forms the wall element is secured via a clamping means inside the pipe, such that the support covers in the installed position the central region of the pipe, but does not cover the edge regions of the pipe inside space. The absorbent materials are installed on the carrier in such a way that these materials swell up and seal the pipe at the installation location, so that no water [swell up and seal the pipe at the installation location, so that no]² or only a small amount of water enters the basement area. ²Note: This portion of the text is repeated in the original, making the sentence confusing.

In a different embodiment, the sealing elements of the absorbent material according to the invention, which are attached to a plate element, are installed around the circumference or over the complete surface. Placing the sealing element onto a sewage system opening and additionally placing an optional heavy weight onto the plate (e.g. a bucket, sand bags, swollen absorbent material, metal plate, rocks) protects the sewage system against a backflow, e.g. caused by heavy rains or flood waters.

The absorbent materials can also be used in the area of flood protection. In particular, they are used for the at least partial sealing of barriers against floodwaters or to form such barriers against floodwaters. Barriers of this type can consist in particular of a stack of normal sand bags or the like, in particular designed as tandem floodwater bags as described in references EP 0659653B1 and DE 29913813U1 and/or as endless bags such as roll goods. Prior to filling the bags, the absorbent materials can separately be allowed to swell up at least partially in a swelling operation, so that technical devices for filling in the sand can also be used.

Swelling bodies containing absorbent materials, which are positioned inside large-pore casings, are particularly suitable for systems of this type. The casings can be jute sacks, nylon stockings or the like. As soon as the non-swollen or slightly swollen swelling agents come in contact with water, they swell up, thus forcing a portion of the absorbent materials to exit through the pores to the outside and form a viscous layer that surrounds the casing. Multiple stacks of these swelling bodies together with the superimposed viscous layers can form an efficient protection against floodwaters and can also be used to seal and raise floodwater dams/levies.

The absorbent materials are generally used as protection against floodwaters, for sealing buildings and building openings such as doors, windows, sewage systems, as well as to protect equipment, e.g. heating systems, air-conditioning systems, switchboards, electrical equipment, furniture, room furnishings. It is also possible to protect complete rooms with a large replacement body, e.g. in the shape of a gas-filled balloon and/or a tent, with absorbent material installed on it, for example inside and/or on the textile materials and/or in honeycomb structures.

The casing, e.g. plastic bags, can alternatively also be mostly or totally impermeable to liquid so that no absorbent material and/or liquids or only an insignificant amount can escape.

For example, absorbent materials, in particular in dense casings, can be used to form barriers/obstructions for fire-extinguishing water when extinguishing fires.

In addition, the absorbent materials can be used to dam or absorb environmental pollutants, particularly in an aqueous solution. For example, absorbent materials can be used to erect barriers along the beaches against oil that has leaked out.

Systems of this type are used in particular for sealing installations relevant to the environmental protection. In particular, condensation water escaping from installations can be absorbed with these materials.

In general, the absorbent materials can be used in the area of purification and cleaning technology, particularly for the water purification and the waste-water treatment. In particular, they can be used to buffer the maximum pollutant values and other waste-water parameters, e.g. the temperature and pH value.

Systems of this type can also be used for the sealing and/or buoyancy protection of ground water or drinking water reservoirs. In the same way, absorbent materials can be used in floodwater retention basins for holding back rainwater and floodwater as reservoirs.

The absorbent materials can advantageously be used for rescue equipment, in particular for rescue equipment used in the water. The absorbent materials can, for example, constitute components of life preservers or the like. Another example of this is a diver rescue system. For this, a mixture consisting of a gas generator such as sodium carbonate and an absorbent agent is provided inside a diving suit and/or in an additional and possibly outer elastic hollow area, e.g. a balloon. In case of an emergency, the diver under water can flood the diving suit and/or the additional hollow space, so that water comes in contact with the mixture. In the process, the absorbent material will swell up. As a result of the sodium carbonate coming in contact with the water, CO₂ gas is generated and released, particularly in small bubbles, inside the absorbent material. This results in buoyancy forces that bring the diver to the surface of the water. The same principle can also be used as additional safety measure for swim rings or water wings for children. In that case, the small amount of the mixture that is used, e.g. 1/100 of the final volume, is particularly advantageous.

Different components for various uses can also be manufactured with the absorbent materials.

A first example of this is a gel-type hydraulic component such as a gel-type hydraulic cylinder. The absorbent material is located inside the gel-type hydraulic cylinder. The absorbent material volume increases or decreases, depending on whether water is supplied to or removed from the absorbent material, which results in the lifting movement being carried out.

A different embodiment, designed to prevent water damage in washing machines and dishwashers caused by defective connecting hoses, is known and marketed under the name AQUASTOPP, which is normally triggered electro-mechanically. This product effects the interruption of the continued water supply to a leaking area, which leads to water damage, by using an absorbent material, e.g. in the form of a gel-type hydraulic cylinder, to close the water inflow valve and/or seal the leak.

The absorbent materials can generally be used to secure components. Specifically, the absorbent materials can be used as filler material for walls and wall elements with a sandwich-type design. In addition to the stabilizing characteristics, the absorbent materials also dampen noise, so that walls produced with these materials can also be used as noise-protection walls on the inside or outside of buildings. Absorbent materials used in this way can also function as heat and cold stores for the building climate control.

The absorbent materials can additionally form components of structural parts that function to absorb radiation. Thus, they can be used as heat carriers/heat reservoirs for solar warm-water and/or air collectors.

The absorbent materials can furthermore be used in components to increase the conductivity and/or to screen against electrostatic charge and/or electromagnetic fields. For example, components of this type can be carpets and wallpaper or other textile-type materials. These can also contain additional and especially conductive materials, e.g. metals such as gold, silver, aluminum, copper and especially unprocessed copper.

The absorbent materials can also be used in the form of bulk materials, molded bodies or flat shaped articles as packaging filler materials. Such packaging components can advantageously absorb liquids entering from the outside or leaking from damaged bottles and containers stored inside the packaging, or from food items such as frozen meat or the like.

The absorbent materials can also be used to produce structural components that are used to protect installations against bad weather.

For example, the structural components can be in the form of mats containing absorbent materials. The mats can be used to seal building roof and are preferably rolled up on devices provided for this. In case of the threat of bad weather, the mats are unrolled and used to cover the roof shingles. In the event of strong rain or hail, and/or following a purposeful moistening, the swelling agents swell up, bond with the roof shingles and protect these against being removed from the roof, even during a heavy storm. This also prevents and/or reduces the chance of roof shingles being pulled from the compound roof, thus protecting the building against otherwise penetrating rainwater. In the same way, mats of this type can be used as protection against a hail of broken glass, particularly for motor vehicles or sunrooms or roof windows.

The absorbent materials furthermore are used in installations as secondary and/or buoyancy protection, particularly in LAU (storage, filling and transfer) installations and HBV (production, treatment and use) installations or when handling materials endangering the water, as well as for food items and beverages.

The absorbent materials according to the invention can be used as components in hygienic articles such as diapers, draw-sheets for nursing care patients (incontinence articles) and tampons. For this, the absorbent materials in particular are designed in the shape of layers or molded parts.

The absorbent materials are also suitable for communal and industrial sewage treatment systems, e.g. as pH buffer, pollutant absorber in case of damage or accident, or for units operating based on the ion-exchange principle for buffering the pH value peaks.

The absorbent materials furthermore are suitable as buffer material for buffering and for the slow and/or targeted release of active substances such as attractants, odor-causing agents, biocides and pesticides such as are used against snails and other pests.

For a different type of use, the absorbent materials can be used as odor-absorbing agents in technical and natural exhaust systems for reducing odors, e.g. in recycling installations (composting installations), for the food processing, in breweries, kitchens, slaughterhouses or butcher shops.

The absorbent materials are furthermore suitable for use as water and waste-water pollutant absorbing means and/or as filters for the analysis and pollutant bonding, particularly for wood preservatives.

Also possible is the use as absorbent materials in chemical toilets for human and animal feces and for the reduction of odors.

The absorbent materials are furthermore used as packaging materials or inserts for absorbing liquids/vapors and odors, in particular from food items, plants, animals with the option of functioning simultaneously as temperature store (energy store) for cooling or heating, e.g. for the frozen fish transport in an airplane.

A different option for using the absorbent materials is as water, nutrient and biocatalyst store for plants, possibly with a targeted catalyst release, particularly in and/or on synthetic fiber textiles, natural materials and textiles in the form of woven material, non-woven material or fiber bundles such as jute, coconut, hemp, sisal, cotton, animal hairs, wool, cardboard, cell material, reeds. The absorbent materials in particular form cushions that function as water stores for balcony flowerpots and office plants. The absorbent materials can also be used as components of swelling elements, e.g. in the form of tablets or pots, for promoting the germination and growth of plants, particularly young plants. The absorbent materials furthermore form molded parts of an optional shape and size that can be seeded with any type of seed and/or implanted with plants and can serve as gift article or for the room design.

The absorbent materials can also be used as dusting materials or as a component thereof and serve as animal cage bottom material for absorbing vapors and feces, particularly urine, and to reduce odors.

The absorbent materials can also be used for the water evaporation/humidifying of the room air, for example, particularly on heating elements/units.

The absorbent materials also function to absorb water for dehumidifying the air, e.g. for reducing in particular high air humidity in damp areas, bathing installations or tropical regions.

As a result of the flake-type structure of the absorbent materials, they can also be used to produce artificial snow, wherein the highly elastic flakes in particular can also be used with temperatures above zero. Owing to the high cold/heat storage ability, they can also be used with negative temperatures. The frictional correction value in that case is clearly below that of positive temperatures. Additives, particularly also for the solidifying the snow according to prior art, can be used for this. Buildings, e.g. igloos, in particular made from mechanically produced molded parts consisting of absorbent materials, can also be erected. These molded parts/claddings can be installed directly on the building and can also be removed again once the building is completed.

### Material List A1

Non-biodegradable swelling agents/polymers and cross-linking monomers:

BM: basic polymer

CM: copolymer

BM: acrylamide

CM: 2-(acryloyloxyl)ethylacidphosphate

2-acrylamido-2-methylpropane sulphonic acid

2-dimethyl amino ethylacrylate

2,2′-bis(acrylamido)acetic acid

3-(methacrylamido)propyitrimethyfammoniumchloride

acrylamidomethylpropanedimethyl ammonium chloride

acrylate

acrylonitrile

acrylic acid

diallyldimethylammoniumchloride

diallylammoniumchloride

dimethylaminoethylacrylate

dimethylaminoethylmethacrylate

ethyleneglycoldimethacrylate

ethyleneglycolmonomethacrylate

methacrylamide

methacrylamidopropyltrimethylammoniumchloride

N,N-dimethylacrylamide

N-2 5-(dimethylamino)1-naphthalenyl-sulfonyl-amino-ethyl-2-acrylamide

N-3(dimethylamino)propylacrylamidehydrochloride

N-3(dimethylamino)propylmethacrylamidehydrochloride

BM: poly(diallyldimethylammoniumchloride)

CM: sodium 2-(2-carboxylbenzoyloxy)ethylmethacrylate

sodiumacrylate

sodiumallylacetate

sodiummethacrylate

sodiumstyrolsulphonate

sodiumvinylacetate

triallylaamine

trimethyl(N-acryloyl-3-3aminopropyl)ammoniumchloride

triphenylmethane-leuco-derivatives

vinyl-terminated-polymethysiloxane

BM: N-(2ethoxyethyl)acrylamide

BM: N-3-(methoxypropyl)acrylamide

BM: N-(3ethoxypropyl)acrylamide

BM: N-cytlopropylacrylamide

BM: N-n-propylacrylamide

BM: N-(tetrahydrofurfucyl)acrylamide

BM: N-isopropylacrylamide

BM: 2-(diethylamino)ethylmethacrylate

2-(dimethylaamino)ethylmethacrylate

2-acrylamido-2-methyl-1-propanesulfonateacrylate

acrylic acid

acrylamide

alkylmethacrylate

bis(4-dimethylamino)phenyl)(4-vinylphenyl)methylleucocyanide

concanavalin A (lecitin)

hexyhnethacrylate

laurylmethacrylate

methacrylic acid

methacrylamidopropyltrimethylammoniumchloride

n-sutylmethacrylate

poly(tetrafluoroethylene)

polytetramethylenetherglycol

sodium acrylate

sodiummethacrylate

sodiumvinylsulfonate

vinyl-terminated polymethysiloxane

BM: N,N′-diethylacrylamide

CM: methacrylamidopropyltrimethylammoniumchloride

N-acryloxysuccinimide ester

N-tert.-butylacrylamide

sodiummethacrylat

BM: 2-dimethylaminoethylacrylate

CM: 2-acrylamido-2-methylpropanesulfonic acid

acrylamide

triallylamine

BM: acrylate

CM: acrylamide

BM: methylmethacrylate

CM: divinylbenzenes

N,N-dimethylaminoethylmethacrylate

poly(oxytetramethylenedimethacrylate)

BM: poly(2-hydroxyethylmethacrylate)

BM: poly(2-hydroxipropylmethacrylate)

BM: polyethylene glycolmethacrylate

BM: acrylic acid, partially neutralized acrylic acid (neutralizing agents KOH or NaOH)

CM: methacrylamidopropylene trimethylammoniumchloride

BM: collagen

BM: dipalmitoylphosphatidylethanolamine

BM: poly-4,6-detadien-1.10-diol-bis(n-butoxycarbonylmethylurethane)

BM: poly-bis(aminoethoxy)ethoxyphosphases

BM: poly-bis(butoxyethoxy)-ethoxyphosphases

BM: poly-bis(ethoxyethoxy)-ethoxyphosphases

BM: poly-bis(methoxyethoxy)-ethoxyphosphases

BM: poly-bis(methoxyethoxy)phosphases

BM: polydimethylsiloxane

BM: polyethyleneoxide

BM: poly(ethylene-dimethylsiloxane-ethyleneoxide)

BM: poly(N-acrylopyrrolidin)

BM: poly n,n-dimethyl-N-(methacryloyloxy)-ethyl-N-(3-sulfopropyl)-ammonium betain

BM: polymethacrylic acid

BM: polymethacryloyldipeptide

BM: polyvinyl alcohol

BM: polyvinyl alcohol-vinylacetate

BM: polyvinylmethylether

BM: furan modified poly(n-ocetylethylenimin)

CM: maleinimid modified poly(n-acetylethylenimin)

### Cross-Linking Monomers

N,N′-methylenebiscatrylamide

diallylamine

diallylammoniumchloride

triallylamine

triallylammoniumchloride

diallyl tartaric acid diamide

### Finished Products

general sodiumpolyacrylate

potassium polyacrylate

acrylate resins

acrylic resins

### Material List A2: Biodegradable Swelling Agents

polysaccarides

alginates

alginic acid

amnylose

amylopectin

callose

carrageenan

chitin

dextrane

guluronic acid

inulin

laminarin

moss starch

pullulan

pustulan

xanthan gum

cellulose and cellulose derivatives

cellulose ether

methyl cellulose

starch and starch derivatives

carboxymethyl cellulose

poly asparagine acid

hemp

yeast

polyhydroxyalcanoate

aliphatic polyester-based polyurethanes

aliphatic polyester-based polylactides

aliphatic polyester-based polycaprolactones

3-polyhydroxybutrate [polyhydroxy butanoic acids

3-polyhydroxyhexacopolymer films

### Material List C1

corresponds to the material lists A1 and A2

### Material List C2: Bonding Agents/Adhesive Agents/Surface Cross-Linking Agents

Cations of a multi-valent metal salts, having a valence of 2 or 3, such as can occur with sulfates, acetates, chlorides, nitrates, phosphates, hydroxides, isopropoxides, ethylates, tertiary butoxides.

For example the following metals.

aluminum

iron

chromium

zircon

titanium

calcium,e.g. as calcium chloride

magnesium, e.g. as magnesium chloride

strontium

### Amylopectin

Gelatinizing components in starch (approximately 20% of the starch), water-soluble, thixotropic, biodegradable, suitable for use with food items.

### Carrageenan

Water-soluble, thixotropic algae extract with a water absorption capacity toward 98%, in purified form suitable for use with cosmetic articles and food items and has at least good bio-compatibility; degradable only with special organisms.

Water-soluble poly electrolyte from the general group of cellulose ethers, which can be flocculated out with copper and aluminum salts, wherein copper at the same time would presumably provide a certain amount of protection against microbes. It is probably only conditionally biodegradable, but is bio-compatible. In the purified form it is suitable for use with food items.

### Cellulose Ether

For example low-etherized, still water-soluble methyl cellulose and hydroxy propylene cellulose with an etherizing degree around 1.5 . . . , possibly in conjunction with a polyvinyl acetate such as Methylan TG.

### Dextrins/Cyclodextrins and their Derivatives

Highly water-soluble with a strong bonding effect, also called starch gum, has good biodegradability and is food compatible.

### Galactomanane/Guar Gum

Cellulose-like polymers that are highly water-soluble, biodegradable and are used for thickening food items. They are commercially available, for example, as guar flour or carob seed flour.

Resin Soaps

For example, saponified collophonium, water-soluble as Na and K salt, sticky, viscous solutions (water-soluble as calcium salt; formerly used to cement the knots in fishing nets to improve the non-slip characteristics). Has only a limited biodegradability, but is nature-compatible).

### Polyvinyl Alcohol

Generally water-soluble up to molecular weights of 200,000.—; lower but lighter. Can be cross-linked with copper, borax, aldehydes and other agents, thus reducing the water-solubility. Limited biodegradability depending on the sewage treatment plant population. Foamed products possible. Interestingly, this product is resistant to fats and expanding agents. Is used in the textile industry as sizing agent (for stabilizing the warp threads by enveloping them for mechanical protection) for synthetic fibers!

### Traganth Gum

Water-soluble plant gum that is only partially soluble, is suitable for food use and is relatively expensive.

### Lignin

Methyl cellulose, possibly in combination with synthetic resin, e.g. Methylan TT Instant.

N,N-methylenebis(meth)acrylamide

(Poly)ethyleneglycol-di(meth)acrylate

Trimethylopropane-tri(meth)acrylate

Glycerin-tri(meth)acrylate

Triallylamine

Triallylcyanurate

Triallyl isocyanate

Glycydil-(meth)acrylate

(Poly)ethyleneglycoles

Polyalkyleneglycoles

diethyleneglycoles

(Poly)-glycerines

Propylene glycol

Diethanol amine

Trimethylolpropane

Pentaerythritol

(Poly)ethyleneglycol-diglycidether

(Poly)glycerin-polyglycidether

Epichlorohydrin

Ethylenediamine

Polyethylenimine

(Poly)aluminum chloride

Stearin waxes

Paraffin waxes

Gel waxes: also on the basis of medical white oil

Fatty acids and their derivatives

Shellac

Colophonium

Latex

Silicic acid

These bonding agents that can melt; are based on polyolefins, polyamides, poylesters, poly(meth)acrylates, poly(meth)acrylnitriles, polyalkylene oxides, polyvinyl chloride, polystyrene, polycarbonates, polyurethanes.

### Material List C3: Aggregation Inhibitors

Liquid glass, e.g. sodium—and potassium liquid glass

Carboxymethylcellulose, if necessary hydrophobic

Guar gum, if necessary hydrophobic

Cellulose ether, if necessary with polyvinyl acetate

Titanium oxide (20-300 nm)

Aluminium oxide (20 nm)

Attapulgite alumina capable of swelling (140 nm)

Foamed silica, e.g. of the type Cabosil EH-5 (8 nm)

### Material List C4: Filler Materials

### Mineral Agents

For example sand, clay, expanded clay, loam, perlite, pumice, betonites, burning ashes, glass particles such as aerosil (hollow glass spheres), glass fibers, barite, silicic acid, spar, basalt, chalk, talcum, lime, magnesium oxide, titanium oxide, dolomite, calcium carbonate, carbon black, zinc white, gypsum, kaolin, mica, kieselguhr.

### Plant Materials

For example plant fibers from coconut, hemp, flax, cotton, linseed, cell material (byproduct of the paper production), wood dust.

### Animal Materials

For example wool, bone meal.

### Synthetic Materials

In particular for example foamed or non-foamed synthetic materials; for example synthetic textile fibers, ground rubber/rubber dust.

### Material List C5: Capillary Materials

1. Surfactants (super cross-linking agents)

2. Non-woven material/textiles/particles with high capillary effect such as holophilic fibers (hollow fibers), Dunova textiles, microfibers, flax fibers, coconut fibers, hemp fibers, cotton fibers, wool fibers, paper, cardboard, wood fibers, cell material, luffa fiber cucumber (skeleton)

3. Mineral particles

4. For example clay, expanded clay, pumice and plant granulates.

### Material List C6: Antiblocking Agents

1. Plastics

2. For example PTFE (polytetrafluoroethylene) plastics

3. Silicones

### Material List C7: Friction Materials

Materials having a high friction factor/coefficient:

Rubber, e.g. tire rubber, refined rubber dust

Caoutchouc, synthetic and natural

Latex

Soft PVC (polyvinylchloride), e.g. as used for anti-skidding mats “Black-Cat.”

### Material List 8: Auxiliary Processing Agents

### Biocides

Alkyltrimethylammoniumchloride, dialkyltrimethylammoniumchloride, dimethyl-distearylammoniumchloride, methosulfate, tallow imidazoliniummethosulfate.

### Corrosion Inhibitors

Urea

1. A method for producing an absorbent material for water and aqueous solutions and body fluids, characterized in that the absorbent material consist of at least two components Q and B, namely the component Q with 100 parts by weight of particles and the component B with 2 to 250 parts by weight of water, and that a homogeneous mixing of the components creates an absorbent material with a cavity-type flake as a result of mutual adhering of the particles to each other and/or a covalent and/or ionic bonding and that immediately after the mixing, the bulk and/or cavity volume increases by at least 1% by volume, relative to the sum of individual volumes for the components used, which together represent 100% by volume.

2. The method according to claim 1, characterized in that the component Q consists of at least one synthetic polymer or copolymer with the capacity to swell in water and/or at least one natural or synthetic polymer compound, which at the normal temperature is in the form of a pourable powder or granulate and is soluble in water only to a limited degree or not at all, and/or that the component Q is surface treated and can be used as finished product, and/or is subjected to an after-treatment for restoring the gel permeability following mechanical damage, in particular by using a solution containing at least one salt of an at least three-valent cation.

3. The method according to claims 1 and 2, characterized in that the component Q consists of a combination of various swelling agents and that one or several different swelling agents of the ones contained in the Material Lists A1 and A2 are present in a mixture for a single flake forming a micro-flake structure and/or in a mixture and/or compound of several individual flakes that form a macro-flake structure.

4. The method according to claim 3, characterized in that the macro-flake structure is present in an optional three-dimensional form or layering and/or contour and/or distribution intensity of the micro-flake structures and, in particular, forms one or several functional storage areas and/or distribution areas.

5. The method according to claims 1 to 4, characterized in that the component B contains solid and/or liquid/dissolved and/or gaseous admixtures, in particular consisting of the materials in the categories swelling agents, bonding agents, adhesive agents, surface cross-linking agents, aggregation inhibitors, filler materials, capillary materials, blocking agents, frictional materials, auxiliary processing aids.

6. The method according to claim 5, characterized in that the components Q and/or B respectively are composed of a mixture of various particle sizes, wherein particularly the component Q has a particle distribution of 0.001 μm to 20,000 μm, preferably ranging from 1 μm to 10,000 μm and especially preferred from 5 μm to 5,000 μm and typically from 10 μm to 1,000 μm for commercially available hygienic products.

7. The method according to claim 6, characterized in that the particles of the component Q and the component B have an optional outside contour which, in particular, can have a spherical or conical shape, an irregular powder grain shape, or can be cube-shaped or cylindrical as for fibers, drop-shaped or star-shaped and is provided, in particular, with a surface structuring in the form of grooves, indentations and holes.

8. The method according to claim 7, characterized in that the particles of the component Q have an optional inside contour and, especially, can be spherical, conical, cubical, cylindrical in shape as for hollow fibers, drop-shaped or star-shaped and, in particular, are provided with an inside surface structuring in the form of grooves, indentations and holes.

9. The method according to one of the claims 1-8, characterized in that a simple mixing unit or stirring mechanism is used for mixing the components of the absorbent material.

10. The method according to claim 9, characterized in that the simple mixing unit or the stirring mechanism operates with a rotational speed in the range of 200 to 1000 rpm.

11. The method according to claim 10 or 11, characterized in that a horizontal mixer or a cement mixer is used as the mixing unit.

12. The method according to claim 10 or 11, characterized in that for component shares exceeding 10% and grain sizes smaller than 100 μm, particularly smaller than 50 μm, gravity mixers or fluidized-bed mixers are used.

13. The method according to one of the claims 9-12, characterized by the following sequence of operations:
a) Start-up of a mixing unit, designed as horizontal mixer, with a mixing volume of 15 l and a rotational speed of 300 rpm.
b) Adding a starting amount of 100 parts by weight of the component Q.
c) Supplying component B in the form of water with 2 to 250 parts by weight, preferably 40 to 150 parts by weight, and especially preferred over a period of a few seconds.
d) Mixing of the components Q and B until they are sufficiently homogenized and the absorbent material simultaneously forms cavity-forming flakes, in particular over a period of 30 minutes.

14. The device according to claim 13, characterized in that prior to realizing the process step c, a second amount of the component B is added, particularly in the form of aggregation inhibitors, in particular 30 parts by weight of methyl cellulose Methlan TG, which is mixed over a period of 5 minutes with the component Q.

15. The method according to claim 13 or 14, characterized in that prior to the process step b), a batch of at least one of the following materials is added, namely water, a liquid, a solution of components B and/or Q, a finished product and/or an intermediary product of the absorbent material, and/or a pre-swollen material.

16. The method according to one of the claims 13-15, characterized in that during the production of the absorbent material, one or several partial batches of water or liquid mixtures of the components Q and/or B, especially aggregation inhibitors, are added during and even shortly before the end of the mixing process.

17. The method according to one of the claims 13-16, characterized in that one or several partial batches of the components to be used are added in dependence on the mixing result so far, in dependence on one or several samples taken during the mixing process and/or in dependence on one or several of the following criteria: the bulk volume/cavity increase, the density, the relative humidity, the elastic behavior, the stickiness, the pouring behavior, the frictional values after the swelling, the release of in particular gaseous agents, the appearance of the flake for the absorbent material.

18. The method according to one of the claims 1-17, characterized in that water is supplied continuously during the mixing process, in particular in the form of a sprayed stream for generating water drops and/or water vapor and/or hot steam.

19. The method according to one of the claims 1-18, characterized in that during the production of the absorbent material one or several treatment steps are realized several time in the same or a changed sequence, with the same or changed process parameters.

20. The method according to one of the claims 1-18, characterized in that heating/drying operations take place during the absorbent material production.

21. The method according to claim 1 or 2, characterized in that immediately after the mixing of the components and/or up to 24 hours later, the bulk volume and/or the cavity volume increases at least from 1 to 1000% by volume, preferably 5 to 500% by volume and especially preferred 50 to 300% by volume, relative to the sum of individual volumes for the components used, which add up to 100% by volume.

22. The method according to one of the claims 1-3, characterized in that immediately after the mixing of the components and/or up to 24 hours thereafter, an elasticity value for the elastic behavior under load of at least 5N/dm², preferred >20N/dm², particularly preferred >30N/dm² is obtained relative to the comparable value without load.

23. The method according to one of the claims 1-4, characterized in that the frictional behavior of the absorbent material during and after the swelling is improved by adding swelling agents and admixtures, particularly in the form of frictional materials with a high frictional coefficient, in particular “Black-Cat” and rubber dust.

24. An absorbent material that can be obtained with the method according to one of the claims 1-23.

25. The use of the absorbent material according to claim 24 for securing the position of containers and/or to prevent buoyancy.

26. The use of the absorbent material according to claim 24 as sealing agent.

27. The use of the absorbent material according to claim 24 for sealing two rooms or room sections.

28. The use of the absorbent material according to claim 24 in the form of a cable sealer.

29. The use of the absorbent material according to claim 24, in particular in the swelled-up state, for setting up barriers as protection against floodwaters or to contain water used to extinguish fires, or to use as booms to prevent the spread of environmentally damaging substances, particularly crude oil.

30. The use of the absorbent material according to claim 24 for manufacturing rescue equipment, in particular equipment used for water rescue.

31. The use of the absorbent material according to claim 24 for producing structural components, particularly gel-type hydraulic cylinders.

32. The use of the absorbent material according to claim 24 for producing filler materials and/or packaging components.

33. The use of the absorbent material according to claim 24 for producing devices that protect against bad weather.

34. The use of the absorbent material according to claim 24 in LAU (storage, filling, transfer) installations and HBV (production, treatment and use) installations and for food items and beverages as secondary and/or buoyancy protection systems.

35. The use of the absorbent material according to claim 24 in hygienic articles, particularly diapers, incontinence articles, tampons, in particular in the form of layers or molded parts.

36. The use of the absorbent material according to claim 24 in the field of waste-water treatment as pH value buffer or pollutant absorber.

37. The use of the absorbent material according to claim 24 as buffering agent for the absorption and targeted release of active agents, in particular blocking agents, odorous substances, biocides or pesticides.

38. The use of the absorbent material according to claim 24 as odor-absorbing agent in air-exhaust systems.

39. The use of the absorbent material according to claim 24 for treating human and animal feces in chemical toilets.

40. The use of the absorbent material according to claim 24 as water reservoir, nutrient reservoir and/or active agent reservoir for plants.

41. The use of the absorbent material according to claim 24 as dusting material.

42. The use of the absorbent material according to claim 24 for humidifying and/or dehumidifying the room air.

43. The use of the absorbent material according to claim 24 as artificial snow. blocking agents, frictional materials, auxiliary processing aids.
